(19) United States
(12) Patent Application Publication
(10) Pub. No.: US 2022/0044026 A1
(43) Pub. Date: Feb. 10, 2022

(54) METHOD FOR GENERATING CLIPPING TEMPLATE, AND ELECTRONIC DEVICE

(71) Applicant: BEIJING DAJIA INTERNET INFORMATION TECHNOLOGY CO., LTD., Beijing (CN)

(72) Inventor: Weibin HUANG, Beijing (CN)

(21) Appl. No.: 17/498,965

(22) Filed: Oct. 12, 2021

Related U.S. Application Data
(63) Continuation of application No. PCT/CN2020/128702, filed on Nov. 13, 2020.

(30) Foreign Application Priority Data
Jan. 2, 2020 (CN) 202010003242.1

(51) Int. Cl. G06K 9/00; G11B 27/034

(52) U.S. Cl. CPC G06K 9/00751; G06K 9/00765; G11B 27/034

(57) ABSTRACT

A method for generating a clipping template is provided. In the method, clipping information of a target multimedia resource is acquired in response to a template generation request for the target multimedia resource, wherein the clipping information includes at least one of clip operation information or clipping material information; clipping information conforming to a target type is selected from the clipping information of the target multimedia resource, and template data is determined based on the selected clipping information; and a clipping template is generated based on the template data.

### CROSS-REFERENCE TO RELATED APPLICATION

This disclosure is a continuation application of International Application No. PCT/CN2020/128702, filed on Nov. 13, 2020, which claims the priority to Chinese Application No. 202010003242.1, filed on Jan. 2, 2020. Both applications are incorporated herein by reference in their entireties.

### TECHNICAL FIELD

The present disclosure relates to the field of multimedia technologies, and in particular, relates to a method for generating a clipping template, and an electronic device.

### BACKGROUND

With the development of multimedia technologies, people often produce multimedia resources by clipping multimedia resources to obtain better audio-visual effects.

### SUMMARY

The present disclosure provides a method for generating a clipping template, and an electronic device.

According to one aspect of embodiments of the present disclosure, a method for generating a clipping template is provided. The clipping template is configured to clip a multimedia resource. The method includes:

acquiring clipping information of a target multimedia resource in response to a template generation request for the target multimedia resource, wherein the clipping information of the target multimedia resource includes at least one of clip operation information or clipping material information;

selecting clipping information conforming to a target type from the clipping information of the target multimedia resource, and determining template data based on the selected clipping information; and

generating the clipping template based on the template data.

According to another aspect of embodiments of the present disclosure, an electronic device is provided. The electronic device includes:

one or more processors; and

one or more memories configured to store one or more instructions executable by the one or more processors;

wherein the one or more processors, when loading and executing the one or more instructions, are caused to: acquire clipping information of a target multimedia resource in response to a template generation request for the target multimedia resource, wherein the clipping information of the target multimedia resource includes at least one of clip operation information or clipping material information; select clipping information conforming to a target type from the clipping information of the target multimedia resource, and determining template data based on the selected clipping information; and generate a clipping template based on the template data, wherein the clipping template is configured to clip a multimedia resource.

According to another aspect of embodiments of the present disclosure, a non-transitory storage medium storing one or more instructions therein is provided, wherein the one or more instructions, when loaded and executed by a processor of an electronic device, cause the electronic device to: acquire clipping information of a target multimedia resource in response to a template generation request for the target multimedia resource, wherein the clipping information of the target multimedia resource includes at least one of clip operation information or clipping material information; select clipping information conforming to a target type from the clipping information of the target multimedia resource, and determining template data based on the selected clipping information; and generate a clipping template based on the template data, wherein the clipping template is configured to clip a multimedia resource.

### BRIEF DESCRIPTION OF THE DRAWINGS

FIG. 1 shows an implementation environment of a method for generating a clipping template according to an exemplary embodiment;

FIG. 2 is a flowchart of a method for generating a clipping template according to an exemplary embodiment;

FIG. 3 is a schematic diagram of a terminal interface according to an exemplary embodiment;

FIG. 4 is a schematic structural diagram of an apparatus for generating a clipping template according to an exemplary embodiment;

FIG. 5 is a structural block diagram of a terminal according to an exemplary embodiment; and

FIG. 6 is a schematic structural diagram of a server according to an exemplary embodiment.

### DETAILED DESCRIPTION

User information involved in the present disclosure may include information authorized by a user or fully authorized by various parties.

In the related art, clipping a multimedia resource usually requires high technical skills. Therefore, some applications that provide clipping functions for multimedia resources have been developed, which provide clipping templates for users, such that an ordinary user who is even not skilled in clipping can easily call the clipping template to clip a multimedia resource. However, the clipping templates provided by the applications are usually fixed templates, and thus personalized clipping demands of some users cannot be accommodated.

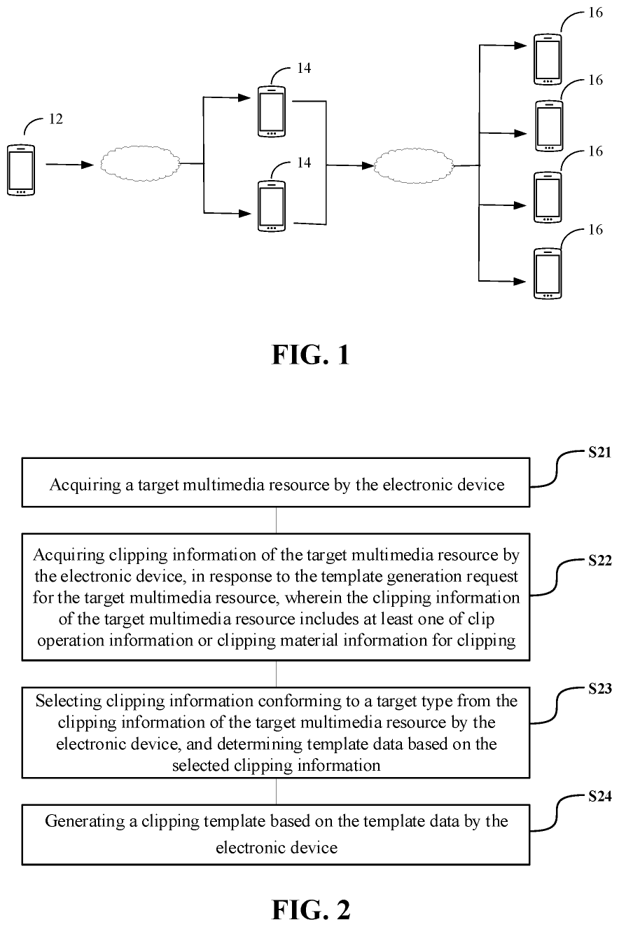

FIG. 1 shows an implementation environment of a method for generating a clipping template according to an exemplary embodiment. As shown in FIG. 1, the implementation environment involves a plurality of electronic devices. In some embodiments, the electronic device is a terminal or a server. In FIG. 1, the case where the electronic device is a terminal is used as an example for illustration.

Referring to FIG. 1, the method for generating a clipping template is applicable to a first electronic device 12. In some embodiments, in response to generating a clipping template, the first electronic device 12 sends the clipping template to second electronic devices 14 through cloud, to share and disseminate the clipping template. In some embodiments, the second electronic devices 14 send the clipping template to third electronic devices 16 through the cloud. The second and third electronic devices 14, 16 are also capable of generating the clipping template, using the method of the present disclosure.

In an embodiment of the present disclosure, a method for generating a clipping template is provided. The method for generating a clipping template is configured to generate a clipping template based on a target multimedia resource. In the generating process, the clipping template is generated based on clipping information of the target multimedia resource. FIG. 2 is a flowchart of a method for generating a clipping template according to an exemplary embodiment. Referring to FIG. 2, the method for generating the clipping template is applicable to an electronic device and includes the following processes.

In S21, the electronic device acquires a target multimedia resource.

In embodiments of the present disclosure, the electronic device acquires a target multimedia resource, wherein the target multimedia resource is a clipped multimedia resource. The electronic device generates a clipping template based on clipping information of the target multimedia resource. That is, the clipping template similar to the clipping situation of the target multimedia resource is acquired. In this way, a new multimedia resource can be subsequently generated by using the clipping template. Clipping of the generated multimedia resource is similar to the clipping of the target multimedia resource.

In some embodiments, the target multimedia resource is acquired by clipping on the electronic device, or acquired by receiving a clipped target multimedia resource from another electronic device, or acquired by downloading from a target address by the electronic device. A specific source of the target multimedia resource is not limited in embodiments of the present disclosure.

For example, the target multimedia resource being a video is taken as an example. In the case that the video is clipped by an electronic device of a user and the user is satisfied with a playback effect of the video, the electronic device of the user generates a clipping template based on the video, and subsequently, a video having the same or similar clipping effect as the video can be acquired quickly and efficiently based on the clipping template. In another example, in the case that the user likes a video clipped by another user terminal, the user terminal generates a clipping template based on the video, and the user can subsequently make his/her own video based on the generated clipping template, such that a video production need of the user is met while a user's personalized clipping need is also met, and thus clipping efficiency and user experience are improved.

In S21, the electronic device may acquire the target multimedia resource and display the target multimedia resource, such that the user sees a display effect of the target multimedia resource. The user can generate a clipping template similar to the clipping situation of the target multimedia resource in the case that the user is satisfied with the display effect of the target multimedia resource. In this way, a new multimedia resource can be quickly generated based on the clipping template, which is convenient and quick. The clipping situation of the new multimedia resource is similar to the clipping situation of the target multimedia resource. Moreover, the clipping template can be generated simply based on the clipped target multimedia resource and without help from a technician, such that a clipping template conforming to a clipping habit of the user can be generated. In addition, the clipping template is not fixed and is flexible and variable in form.

In some embodiments, the user operations and the process for generating the clipping template may be performed on the same device, or the user operations and the process for generating the clipping template may be performed on different devices, which is not limited in embodiments of the present disclosure.

For example, in the case that the user operations and the process for generating the template are performed on the same device, when the user sees the target multimedia resource displayed on the electronic device and wants to generate the clipping template, the user triggers a template generation request for the target multimedia resource by performing a template generation operation in the electronic device. The electronic device directly responds to the template generation request to perform the following processes. The template generation operation is to select the target multimedia resource and trigger the template generation control. In the case that the user operations and the process for generating the template are performed on different devices, the user performs the template generation operation on another device and triggers a template generation request; the other device sends the template generation request to the electronic device. Thus, the electronic device performs S21, and performs S22 in response to the template generation request.

In some embodiments, the template generation request carries a resource identifier of the target multimedia resource, and S21 includes: by the electronic device, receiving the template generation request sent by another device, and acquiring the target multimedia resource indicated by the resource identifier based on the resource identifier carried in the template generation request. In some embodiments, the template generation request carries the target multimedia resource, and S21 includes: by the electronic device, receiving the template generation request, and acquiring the target multimedia resource carried in the template generation request.

In S22, the electronic device acquires clipping information of the target multimedia resource in response to the template generation request for the target multimedia resource, wherein the clipping information of the target multimedia resource includes at least one of clip operation information or clipping material information for clipping.

The term “at least one” implies one or more. For example, the clipping information including at least one of clip operation information or clipping material information means that the clipping information includes the clip operation information or the clipping material information, or the clipping information includes the clip operation information and the clipping material information.

For the received template generation request, the electronic device generates a template in response to the template generation request. The electronic device acquires the clipping information of the target multimedia resource, and takes the clipping information of the target multimedia resource as the base of data/information for generating the clipping template. The clipping information includes at least one of clip operation information or clipping material information for clipping. That is, during the process of clipping a multimedia resource, some attributes of the multimedia resource may be modified by a clip operation, and some materials can be added to the multimedia resource, such that the target multimedia resource can be acquired by combining materials and the multimedia resource.

In some embodiments, the clip operation information includes information of at least one of adjusting a picture frame, adjusting a video ratio, scaling the frame, moving the frame, changing speed, reversing, rotating, changing sound, changing volume, adding a transition, adding a filter, adding music, adding a sound effect, adding dubbing, adding a subtitle, adding a sticker, adding a cover, and the like. In some embodiments, the clip operation information further includes information of other clip operations, which are not enumerated herein. In some embodiments, the clipping material information for clipping includes information of at least one of a filter, music, a sound effect, a sticker, and a cover. In some embodiments, the clipping material information for clipping further includes other clipping material information, which is not enumerated herein.

The clip operation information includes an operation type and/or operation content of at least one clip operation. In some embodiments, the operation type includes, but is not limited to, adjusting a picture frame, adjusting a video ratio, scaling the frame, moving the frame, changing speed, reversing, rotating, changing sound, changing volume, adding a transition, adding a filter, adding music, adding a sound effect, adding dubbing, adding a subtitle, adding a sticker, adding a cover, and the like. For example, the operation type includes adjusting the picture frame, and the operation content is adjusting a size of the picture frame. This is only an example herein and does not cause a limitation to the present disclosure. In other embodiments, an operation sequence of clip operations is different, and thus, final clipping effects of the multimedia resource can be different. The clip operation information further includes an operation sequence of a plurality of clip operations. For example, the user performs a plurality of types of clip operations (such as reducing a frame in a first operation, enlarging the frame in a second operation, and reducing the frame in a third operation), and the electronic device records the operation sequence of the clip operations.

With respect to the clipping material information, the clipping material information for clipping includes a material type, material content, or a material acquisition manner of at least one material. In some embodiments, the material type may include filter, music, sound effect, sticker, cover, and the like. The material type may further include other material types, which are not enumerated herein. In some embodiments, the material content is the material itself for clipping. For example, the material content is an audio file, a configuration file corresponding to a sound effect, a sticker, or a picture corresponding to a cover. In some embodiments, the material acquisition manner includes an acquisition address of the material. For example, the material content is stored in the acquisition address, and the material content can be directly acquired from the acquisition address.

In S22, the electronic device acquires the clipping information in a plurality of manners. In some embodiments, the clipping information is information recorded in the clipping process. The information recorded in the clipping process is stored in a clip operation log. Therefore, the clipping information can be extracted from the clip operation log. In some other embodiments, the clipping information is information acquired by performing comparison analysis on the target multimedia resource and an original multimedia resource. The manner adopted for acquiring the clipping information is not limited in embodiments of the present disclosure. In some embodiments, two manners are provided below.

In the first manner, the electronic device acquires the clip operation log of the target multimedia resource, and extracts clipping information for clipping the target multimedia resource from the clip operation log. The clipping information set may include different information, and thus there may be different implementations for the first manner. In some embodiments, the clipping information includes the clip operation information, and the electronic device extracts the clip operation information of the target multimedia resource from the clip operation log. The clip operation information describes all clip operations for the target multimedia resource or a final clip operation result.

After the clip operation log is acquired, the clip operation information in the clip operation log is taken as a base of the data for generating the clipping template, such that the clipping template can indicate an actual clipping process of the target multimedia resource. By clipping the multimedia resource based on the clipping template generated in this way, clipping the multimedia resource with similar or same clipping processes is implemented, such that the display effect of the acquired new multimedia resource is similar to the display effect of the target multimedia resource. The clipping process is accurate, and the acquired clipping template more conforms to clipping habits of the user, thereby better meeting the need of the user.

In some other embodiments, the clipping information includes the clipping material information for clipping. The electronic device extracts clipping material information for clipping the target multimedia resource from the clip operation log, wherein the clipping material information includes a material type, material content, or a material acquisition manner of at least one material.

After the clip operation log is acquired, the clipping material information in the clip operation log is taken as the data base for generating the clipping template, such that the clipping template that conforms to the clipping habits of the user and meets the need of the user is generated.

In some embodiments, the clipping information includes the clip operation information and the clipping material information. Both the clip operation information and the clipping material information are acquired from the clip operation log, such that the generated clipping templates are rich and diverse, flexible and changeable in form. Convenience is brought for both the clip operation and material, the user operations are simplified, and a generation effect and practicability of the clipping template are improved.

In the first manner, in the case that the user clips the multimedia resource on the electronic device, the electronic device records the clip operation information of the clip operations performed by the user or the used clipping material information, and stores the clip operation information or the clipping material information in the clip operation log. In the case that the target multimedia resource is acquired by clipping, the clip operation log can be taken as a history clipping path of the target multimedia resource. The process of acquiring the target multimedia resource by clipping can be clearly known through the clip operation log.

In some embodiments, the clip operation log includes various cases. In a first case, a clipping record includes clip operation information or used clipping material information of each clip operation. The clip operation is a clip operation that is performed by the user and detected by the electronic device. In a second case, the clip operations performed by the user are managed to acquire the clip operation information or the used clipping material information, such that the clip operation information or the used clipping material information can indicate a final clipping effect of the target multimedia resource. For example, in the second case, operation content of the clip operations with different operation types are combined by the electronic device, to acquire information of the managed clip operations. In another example, in the first case, the clipping record can record a plurality of operations of the user, and the final clipping result is a final result acquired by performing the plurality of operations.

For instance, the user can reduce the frame once and enlarge the frame once, and the final clipping result is that the frame is enlarged. In the first case, the clipping record includes the operation type of reducing the frame and the operation content of a scale for reducing the frame, as well as the operation type of enlarging the frame and the operation content of a scale of enlarging the frame. In the second case, the clipping record directly records the operation type of reducing/enlarging the frame, and the operation content is the specific proportion/scale of the enlarged frame.

In a second manner, the electronic device acquires an original multimedia resource, and acquires the clipping information of the target multimedia resource by comparing the original multimedia resource and the target multimedia resource. The target multimedia resource is acquired by clipping the original multimedia resource.

The electronic device directly compares the target multimedia resource and the original multimedia resource. In the case that there is a difference between the two resources, how to transform from the original multimedia resource to the target multimedia resource can be analyzed, and the transformation process is the clipping information. Because the clipping information can be acquired by comparing the two multimedia resources, it is unnecessary to record the clipping processes one by one, and the final clipping effect of the target multimedia resource can be directly acquired based on the comparison. By generating the clipping template based on such clipping information, the generation process can be completed quickly and efficiently, and the generated clipping template can indicate the final clipping effect of the target multimedia resource, conforms to the clipping habits of the user or needs of the user, and improves the generation efficiency.

In some embodiments, the multimedia resource is a video, and the electronic device compares the target multimedia resource and the original multimedia resource frame by frame. In the case that there is a difference between any video frame of the target multimedia resource and the original multimedia resource, at least one of clip operation information or used clipping material information needed to transform from the video frame of the original multimedia resource to the video frame of the target multimedia resource is acquired. In the case that a difference is present between a plurality of video frames of the target multimedia resource and the original multimedia resource, clip operation information or clipping material information corresponding to each video frame that has a difference can be acquired by using the above method. Clip operation information corresponding to the plurality of video frames constitutes the clip operation information of the target multimedia resource, and clipping material information corresponding to the plurality of video frames constitutes the clipping material information of the target multimedia resource.

In S23, the electronic device selects clipping information conforming to a target type from the clipping information of the target multimedia resource, and determines template data based on the selected clipping information.

In embodiments of the present disclosure, the generated clipping template is used for clipping a multimedia resource subsequently. The multimedia resource is directly clipped subsequently based on the clipping template, and it is unnecessary to repeat the same clip operation. The clip operation information or clipping material information included in the clipping information may not be universal. Thus, the non-universal clipping information does not need to be used as required content to generate the clipping template. The clipping template is generated by using the universal clipping information, such that the clipping template can be used repeatedly, thereby effectively improving the utilization rate and practicability of the generated clipping template.

In some embodiments, whether the clipping information is universal is determined by relevant technicians based on requirements. For example, the target type is determined, and there may be one or more target types. In S23, the electronic device may perform different processes regarding the different information that may be included in the clipping information.

In the case that the clipping information of the target multimedia resource includes the clip operation information, the target type includes a target operation type. Accordingly, in S23, the electronic device selects clip operation information conforming to the target operation type from the clip operation information of the target multimedia resource that is acquired by the electronic device, and determines the template data based on the selected clip operation information. The selected clip operation information that conforms to the target operation type is universal, and the subsequently generated template data can indicate the universal clip operation process in the clipping process of the target multimedia resource. Thus, this not only conforms to the clipping habits of the user, but also meets the needs of the user. In addition, special clipping of a single multimedia resource by the user can be eliminated, such that the acquired clipping template is relatively practical and applicable generally to different or various multimedia resources.

In some embodiments, the clipping information of the target multimedia resource further includes an operation sequence of a plurality of clip operations. In S23, the electronic device correlates the selected clip operation information conforming to the target operation type based on the operation sequence, and determines the correlated clip operation information as the template data.

For example, at least two pieces of clip operation information are selected, each piece of clip operation information conforms to the target operation type, and each piece of clip operation information corresponds to one clip operation. An operation sequence of the clip operations corresponding to the at least two pieces of clip operation information is determined based on the operation sequence included in the clipping information of the target multimedia resource. The at least two pieces of clip operation information are correlated based on the determined operation sequence, and the correlated clip operation information is determined as the template data.

In this way, the operation sequence corresponding to the clip operation information in the template data is clear. Where the clipping template is generated based on the template data, a multimedia resource can be processed in accordance with such an operation sequence based on the clipping template. That is, the clipping on the multimedia resource is same as the clipping performed for acquiring the target multimedia resource. It can be ensured that the clipping method to generate a new multimedia resource is similar to or the same as the clipping method to generate the target multimedia resource, thereby better conforming to the clipping habits of the user. That is, the template data is more accurate, and the generated clipping template more conforms to expectations of the user.

In the case that the clipping information of the target multimedia resource includes the clipping material information, the target type includes a target material type, wherein the target material type is a universal material type. In S23, the electronic device selects clipping material information conforming to the target material type from the clipping material information of the target multimedia resource, and determines the selected clipping material information as the template data. In this case, the clipping information includes the clipping material information, and universal clipping material information is selected from the clipping information and taken as the template data, such that a clipping template is generated subsequently based on the template data. In this way, the clipping template specifies how to clip the material. The new multimedia resource subsequently generated based on the clipping template can include the same or similar material as the target multimedia resource. In this way, the clipping template conforms to the clipping habits of the user in terms of the material, or personalized clipping requirements of the user. The template data can be selected automatically to generate the clipping template, thereby effectively improving the generation efficiency of the clipping template.

Both the clip operation information and the clipping material information have been described above. In some embodiments, the clipping information includes any one of the clip operation information or the clipping material information, or the clipping information includes both the clip operation information and the clipping material information, which is not limited in embodiments of the present disclosure.

In S24, the electronic device generates a clipping template based on the template data.

In response to acquiring the template data by selecting the clipping information, the electronic device can perform the process of generating the clipping template. It can be known from the above process that the information included in the template data can be different. In the case that the information included in the template data is different, the process of generating the clipping template may be different.

In some embodiments, the target type includes a target operation type, the template data includes the clip operation information conforming to the target operation type. In this case, the generation process is as follows. The electronic device generates a clip operation option based on the clip operation information conforming to the target operation type, and generates the clipping template, wherein the clipping template includes the clip operation option. The clip operation option indicates the clip operation. For example, the clip operation information of enlarging a frame includes enlarging the frame and a magnification, and the clip operation option of enlarging the frame is generated based on the clip operation information, and is used as a part of the clipping template.

By performing the above process, the clipping template includes at least one clip operation option. How to clip the multimedia resource can be known based on the clip operation option, and the template data is selected from the clipping information of the target multimedia resource. The clipping method indicated by the clip operation option in the generated clipping template is the same as the clipping method performed for acquiring the target multimedia resource. Therefore, the clipping template conforming to the clipping habits of the users and personalized can be generated based on the template data, without manual processing, thereby improving the generation efficiency of the clipping template; the multimedia resource can be clipped based on the clipping template subsequently, thereby improving the efficiency of clipping the multimedia resource.

In the case that the clip operation information further includes an operation sequence of a plurality of clip operations, at least two pieces of clip operation information in the template data are correlated based on the operation sequence of the clip operations. Accordingly, the process of generating the clipping template is as follows. The electronic device acquires the clipping template including clip operation options and a trigger sequence of the clip operation options by generating the clip operation options and the trigger sequence based on a correlation relationship of the clip operation information conforming to the target operation type.

The clip operation options are generated based on the clip operation information, and a trigger sequence of the clip operation options corresponds to the clipping sequence of the target multimedia resource. Therefore, the clipping template can clearly indicate the clip operations conforming to the target operation type and the corresponding sequence of the clip operations. The clipping template is accurate and fits the actual clipping situation of the target multimedia resource. Therefore, the clipping template more conforms to expectations and clipping habits of the user, and is more practical. The new multimedia resource generated based on the clipping template is closer to the target multimedia resource, and the clipping result is more accurate.

In some embodiments, the target type includes a target material type, and the template data includes clipping material information conforming to the target material type. With respect to the clipping material information, the process of generating the clipping template may be as follows. The electronic device generates a material option based on the clipping material information, and generates the clipping template, wherein the clipping template includes the material option. The clipping material information is converted into a material option in the clipping template. The material option can clearly indicate material information used in clipping of the target multimedia resource. The clipping of the material is the same as the clipping of the target multimedia resource. Therefore, the clipping template generated based on the template data more conforms to the clipping habits of the user, and a clipping result acquired based on this clipping template is more accurate. Thus, a generating effect of the clipping template is better.

In some embodiments, the clipping material information includes a material type, material content, or a material acquisition manner of at least one material. In the process of generating the clipping template, the method further includes followings. The electronic device generates a material acquisition path associated with the material option based on a material type and a material acquisition manner in the clipping material information, and based on material content in the clipping material information, adds the material content to a directory indicated by the material acquisition path.

Attributes of the material option are generated based on information in the clipping material information. The material content can be accurately acquired from the directory corresponding to the material option. After that, clipping is performed based on the material content. The clipping template including the material option is rich in content and flexible in form, and complex clipping can be performed with the generated clipping template based on the material option. The generated clipping template is high in practicability and good in clipping effect. In this way, a new multimedia resource can be generated by using the same material based on the clipping template. The new multimedia resource is similar to the target multimedia resource. Thus, it is easier to meet user's expectations.

In some embodiments, the clipping template is stored as description information. In some embodiments, the description information includes description information of the clip operation, or includes description information of the used material, or includes description information of the clip operation and description information of the used material.

The following provides an example: the clip operation information and clipping material information are called codes. The user clips a video, cuts 0-5 seconds of the video (coded as operation A), adds a superimposing-black transition at the beginning of the video (coded as operation B), adds a piece of light-style music (coded as material a), adds a “clear” filter (coded as material b), adds dubbing commentaries in 0-5 seconds (coded as material c), and then completes the clipping. A program records and stores operations A, B and the used materials a, b, c. The operations A, B are scanned. Based on the definition, the operation A is non-universal and the operation B is universal; the operation B is extracted. The materials a, b, c are scanned. Based on the definition, the material c is non-universal and the materials a, b are universal; the materials a, b are extracted. A clipping template is generated based on the operation B and the materials a, b.

In response to generating the clipping template in S24, the electronic device can further display the generated clipping template. In some embodiments, the electronic device provides a template display interface to display the clipping template. The user can see the displayed clipping template on the electronic device, wherein the clipping template includes at least one of a clip operation option or a material option. In the case that the user wants to preview a clipping effect, the user can perform a preview operation on the clipping template. In this way, the electronic device can receive a preview instruction for the clipping template, and determine a template option corresponding to an operation position in response to the preview instruction, wherein the operation position corresponds to the preview instruction. The template option includes one of the clip operation option or the clipping material option. The electronic device displays preview content of the template option based on template data corresponding to the template option. The operation position corresponding to the preview instruction is an operation position corresponding to the preview operation when the user performs the preview operation. For example, the user taps the clip operation option at any position; the electronic device receives a preview instruction, wherein the operation position corresponding to the preview instruction is the clicking position of the user.

By previewing and displaying the clipping template, the user can view a real clipping effect of the clipping template, and determine whether his/her expected effect is achieved. In the case that the real clipping effect of the clipping template meets the user's needs, the clipping template is utilized. Thus, waste of a computing resource is avoided, wherein the waste is caused by repeatedly generating a multimedia resource because an effect of a multimedia resource generated directly by using the clipping template is not as expected.

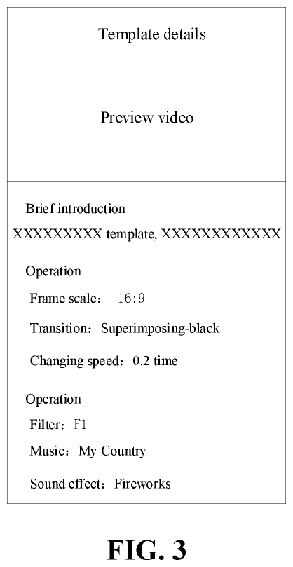

During displaying of the clipping template on the template display interface, the clip operation options can be automatically categorized and displayed based on target operation types. FIG. 3 shows a schematic diagram of a terminal interface according to an exemplary embodiment. As shown in FIG. 3, various clip operation options in the clipping template are categorized and displayed on the terminal interface. For example, the clip operation options may be categorized according to the clipping operation information and clipping material information. In the illustrated example, the operation options related to the clipping operation information include “Frame Scale”, “Transition”, and “Changing Speed”, and the operation options related to the clipping material information include “Filter”, “Music” and “Sound Effect.” The interface may include a video preview region, and a video to be previewed corresponding to the clipping template can be displayed in this region. For example, when the user clicks a button of “Frame Scale”, a schematic diagram of a scaled frame (a scaled-down frame corresponding to a scale of 16:9 in this example) is displayed in the preview video region for the user to view. Similarly, the user clicks a button of “Transition”, and a schematic diagram of a transition is displayed in the preview video region.

In some embodiments, a plurality of operation positions are corresponding to the preview instruction, and the operation positions correspond to a plurality of template options. For example, each operation position corresponds to one template option. In this way, during displaying of the preview content, preview content with superimposed clipping effects is provided based on the template options, such that the user can acquire a real clipping effect, thereby avoiding repeated operations. In some embodiments, the electronic device displays composite content corresponding to the template options based on template data corresponding to the template options, wherein the composite content includes superimposed content of the template options. That is, the composite content is acquired by compositing preview content corresponding to the template options.

In some embodiments, for a plurality of template options corresponding to a plurality of operation positions, the superimposed display process may be as follows. The electronic device acquires a plurality of preview content corresponding to the plurality of template options based on the template data corresponding to the plurality of template options, composites the plurality of preview content to acquire the composite content, and displays the composite content. Each template option corresponds to one piece of preview content, that is, the plurality of template options correspond to a plurality of preview content. By compositing the preview content instead of previewing the content separately, a clipping effect embodying superimposition of a plurality of clipping effects can be exhibited to the user, and is closer to a real clipping effect of the clipping template, such that the situation of repeated clipping caused by an unexpected clipping result can be avoided, thereby improving the diversity of displaying forms and the practicability of the clipping template.

The clipping template can be shared by a current user to other users. In some embodiments, the electronic device sends the clipping template, in response to a share instruction on the clipping template, to a user account indicated by the share instruction. By sharing the clipping template to other users, the user's operations are reduced overall, and the practicability of the clipping template is improved.

In embodiments of the present disclosure, by selecting the clipping information of the target multimedia resource, the clipping information conforming to the target type is selected as the template data, and the clipping template is generated automatically. A corresponding clipping template can be generated based on any target multimedia resource to meet personalized clipping requirements of the user without manual configuration or editing, thereby improving the efficiency of clipping the multimedia resource.

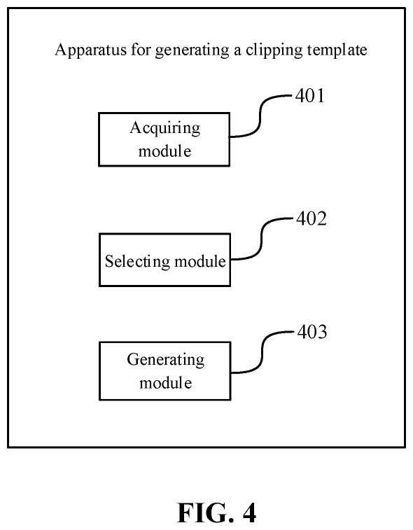

FIG. 4 is block diagram of an apparatus for generating a clipping template according to an exemplary embodiment. Referring to FIG. 4, the apparatus includes an acquiring module 401, a selecting module 402 and a generating module 403.

The acquiring module 401 is configured to acquire clipping information of a target multimedia resource in response to a template generation request for the target multimedia resource, wherein the clipping information includes at least one of clip operation information or clipping material information for clipping.

The selecting module 402 is configured to select clipping information conforming to a target type from the clipping information, and determine template data based on the selected clipping information.

The generating module 403 is configured to generate a clipping template based on the template data.

In the apparatus according to the embodiments of the present disclosure, by selecting the clipping information of the target multimedia resource, the clipping information conforming to the target type is selected as the template data, and the clipping template is generated automatically. A corresponding clipping template can be generated based on any target multimedia resource without manual configuration or editing, thus meeting the personalized clipping demand of the user and improving the user's clipping efficiency for the multimedia resource.

In some embodiments, the clipping information of the target multimedia resource includes the first clip operation information, wherein the clip operation information includes an operation type and/or operation content of at least one clip operation, and the target type includes a target operation type; and

the selecting module 402 is configured to select clip operation information conforming to the target operation type from the clip operation information, and determine the template data based on the selected clip operation information.

In some embodiments, the clip operation information further includes an operation sequence of a plurality of clip operations; and

the selecting module 402 is further configured to correlate the selected clip operation information based on the operation sequence, and determine the correlated clip operation information as the template data.

In some embodiments, the clipping information of the target multimedia resource includes the clipping material information, wherein the clipping material information includes a material type, material content, or a material acquisition manner of at least one material, and the target type includes a predetermined target material type; and

the selecting module 402 is configured to select clipping material information conforming to the target material type from the clipping material information, and determine the selected clipping material information as the template data.

In some embodiments, the target type includes a target operation type, and the template data includes clip operation information conforming to the target operation type; and

the generating module 403 is configured to generate a clip operation option based on the clip operation information conforming to the target operation type, and generate the clipping template, wherein the clipping template includes the clip operation option.

In some embodiments, the clip operation information conforming to the target operation type is correlated based on an operation sequence of a plurality of clip operations; and

the generating module 403 is configured to generate clip operation options and a trigger sequence of the clip operation options based on a correlation relationship of the clip operation information conforming to the target operation type; and generate the clipping template, wherein the clipping template includes at least two clip operation options and a trigger sequence of the at least two clip operation options.

In some embodiments, the target type includes a target material type, and the template data includes clipping material information conforming to the target material type; and

the generating module 403 is configured to generate a material option based on the clipping material information conforming to the target type, and generate the clipping template, wherein the clipping template includes the material option.

In some embodiments, the generating module 403 is configured to: generate a material acquisition path associated with the material option based on a material type and a material acquisition manner in the clipping material information conforming to the target material type; and adds, based on material content in the clipping material information conforming to the target material type, the material content to a directory indicated by the material acquisition path.

In some embodiments, the acquiring module 401 is configured to:

acquire a clip operation log of the target multimedia resource in response to the template generation request; and

extract the clip operation information of the target multimedia resource from the clip operation log, wherein the clip operation information is configured to describe clip operations operated for generating the target multimedia resource or configured to describe a final clip operation result for generating the target multimedia resource.

In some embodiments, the acquiring module 401 is further configured to acquire a clip operation log of the target multimedia resource in response to the template generation request; and extract the clipping material information of the target multimedia resource from the clip operation log, wherein the clipping material information at least includes a material type, material content, or a material acquisition manner of at least one material.

In some embodiments, the acquiring module 401 is configured to:

acquire an original multimedia resource in response to the template generation request, wherein the target multimedia resource is acquired by clipping the original multimedia resource; and

acquire the clipping information of the target multimedia resource by comparing the original multimedia resource and the target multimedia resource.

In some embodiments, the apparatus further includes:

a displaying module, configured to display the clipping template; and

a determining module, configured to, in response to a preview instruction for the clipping template, determine a template option corresponding to an operation position of the preview instruction, wherein the template option includes at least one of a clip operation option or a clipping material option;

wherein the displaying module is further configured to display preview content corresponding to the template option based on template data corresponding to the template option.

In some embodiments, a plurality of operation positions are corresponding to the preview instruction, and each operation position is corresponding to one template option; and

the displaying module is configured to display composite content based on template data corresponding to the template options, wherein the composite content is acquired by compositing preview content corresponding to the template options.

In some embodiments, the displaying module is configured to:

acquire a plurality of preview content corresponding to the template options based on the template data corresponding to the template options; and

acquire the composite content by compositing the plurality of preview content; and display the composite content.

Operations performed by the modules in the apparatus in the above embodiments have been described in detail in the embodiments of the related method, and details are not described herein again.

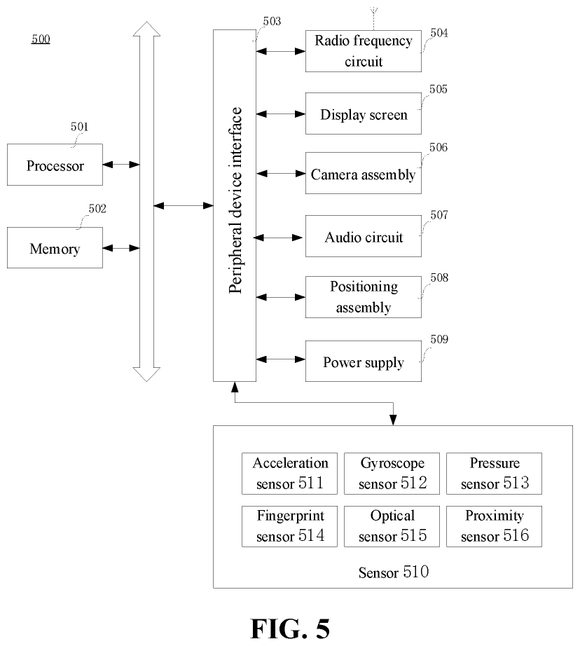

FIG. 5 is a structural block diagram of a terminal according to an exemplary embodiment. The terminal 500 may be a smartphone, a tablet computer, a moving picture experts group audio layer III (MP3) player, a moving picture experts group audio layer IV (MP4) player, a laptop computer, or a desktop computer. The terminal 500 may also be referred to as user equipment, a portable terminal, a laptop terminal, a desktop terminal.

Generally, the terminal 500 includes one or more processors 501 and one or more memories 502.

The processor 501 includes one or more processing cores, such as a quad-core processor and an eight-core processor. The processor 501 may be implemented in at least one of hardware form of a digital signal processor (DSP), a field-programmable gate array (FPGA), and a programmable logic array (PLA). Alternatively, the processor 501 includes a main processor and a coprocessor. The main processor is a processor configured to process data in an awake state, and is also referred to as a central processing unit (CPU). The coprocessor is a low-power-consumption processor configured to process data in a standby state. In some embodiments, the processor 501 is integrated with a graphics processing unit (GPU). The GPU is configured to render and draw content that needs to be displayed by a display screen. In some embodiments, the processor 501 further includes an artificial intelligence (AI) processor. The AI processor is configured to process computational operations related to machine learning.

The memory 502 includes one or more computer readable storage medium, and the computer-readable storage medium may be non-transitory. The memory 502 may further include a high-speed random access memory and a non-volatile memory such as one or more magnetic disk storage devices and flash storage devices. In some embodiments, the non-transitory computer-readable storage medium in the memory 502 is configured to store at least one instruction. The at least one instruction is configured to be executed by the processor 501 to perform the method for generating the clipping template according to the method embodiments of the present disclosure.

In some embodiments, the terminal 500 may further optionally include: a peripheral device interface 503 and at least one peripheral device. The processor 501, the memory 502, and the peripheral device interface 503 are connected by a bus or a signal line. Each peripheral device is connected to the peripheral device interface 503 by a bus, a signal line, or a circuit board. In some embodiments, the peripheral device includes: at least one of a radio frequency circuit 504, a display screen 505, a camera assembly 506, an audio circuit 507, a positioning assembly 508, and a power supply 509.

The peripheral device interface 503 may be configured to connect at least one peripheral device associated with an input/output (I/O) to the processor 501 and the memory 502. In some embodiments, the processor 501, the memory 502, and the peripheral device interface 503 are integrated on the same chip or circuit board. In some other embodiments, any one or two of the processor 501, the memory 502, and the peripheral device interface 503 can be implemented on a separate chip or circuit board, which is not limited in the present embodiment.

The radio frequency circuit 504 is configured to receive and transmit a radio frequency (RF) signal, which is also referred to as an electromagnetic signal. The radio frequency circuit 504 communicates by means of the electromagnetic signal with a communication network and other communication devices. The radio frequency circuit 504 converts an electrical signal to the electromagnetic signal for transmission, or converts the received electromagnetic signal to the electrical signal. In some embodiments, the radio frequency circuit 504 includes: an antenna system, an RF transceiver, one or more amplifiers, a tuner, an oscillator, a digital signal processor, a coding-decoding chip set, a subscriber identity module card, and the like. The radio frequency circuit 504 may communicate with another terminal via at least one wireless communication protocol. The wireless communication protocol includes, but is not limited to, a metropolitan area network, various generations of mobile communication networks (2G, 3G, 4G, and 5G), a wireless local area network, and/or a wireless fidelity (Wi-Fi) network. In some embodiments, the radio frequency circuit 504 may further include a circuit related to near-field communication (NFC), which is not limited in the present disclosure.

The display screen 505 is configured to display a user interface (UI). The UI may include a graph, a text, an icon, a video, and any combination thereof. In the case that the display screen 505 is a touch display screen, the display screen 505 further has a function of acquiring a touch signal on or over the surface of the display screen 505. The touch signal may be input as a control signal to the processor 501 for processing. In this case, the touch display screen 505 is further configured to provide a virtual button and/or a virtual keyboard, which is also referred to as a soft button and/or a soft keyboard. In some embodiments, the display screen 505 is provided as one screen disposed on a front panel of the terminal 500. In some other embodiments, the display screens 505 is provided as at least two screens disposed respectively on different surfaces of the terminal 500 or designed as folded. In other embodiments, the display screen 505 is a flexible display screen disposed on the curved surface or a folded surface of the terminal 500. Furthermore, the display screen 505 may be provided as a non-rectangular pattern, that is, an irregular-shaped screen. The display screen 505 may be a liquid crystal display (LCD) screen, an organic light-emitting diode (OLED) screen, or the like.

The camera assembly 506 is configured to capture an image or a video. In some embodiments, the camera assembly 506 includes a front camera and a rear camera. Generally, the front camera is disposed on a front panel of the terminal, and the rear camera is disposed on a rear surface of the terminal. In some embodiments, there are at least two rear cameras, i.e., a main camera, a depth-of-field camera, a wide-angle camera, and a telephoto camera, to implement a background blur function by combining the main camera and the depth-of-field camera, a panoramic shooting function and a virtual reality (VR) shooting function by combining the main camera and the wide-angle camera, or other fusion shooting functions. In some embodiments, the camera assembly 506 further includes a flashlight. The flashlight is a single-color-temperature flashlight, or a dual-color-temperature flashlight. The dual-color-temperature flashlight is a combination of a warm flashlight and a cold flashlight, and provided light compensation for different color temperatures.

The audio circuit 507 may include a microphone and a speaker. The microphone is configured to acquire sound waves of a user and an environment, convert the sound waves into electrical signals, and input the electrical signals to the processor 501 for processing, or input the electrical signals into the radio frequency circuit 504 to implement voice communication. For the purpose of stereo acquisition or noise reduction, a plurality of microphones is provided and respectively disposed at different parts of the terminal 500. The microphone may be also an array microphone or an omnidirectional acquisition microphone. The speaker is configured to convert electrical signals from the processor 501 or the radio frequency circuit 504 into sound waves. The speaker may be a conventional film speaker or a piezoelectric ceramic speaker. In the case that the speaker is the piezoelectric ceramic speaker, the electrical signal can be converted into not only human-audible sound waves, but also the sound waves that are inaudible to humans for acquire and other purposes. In some embodiments, the audio circuit 507 further includes a headphone jack.

The positioning assembly 508 is configured to determine a current geographic location of the terminal 500 to implement navigation or location based service (LBS). The positioning assembly 508 may the United States' Global Positioning System (GPS), Russia's Global Navigation Satellite System (GLONASS), China's BeiDou Navigation Satellite System (BDS), and the European Union's Galileo Satellite Navigation System (Galileo).

The power supply 509 is configured to supply power for various assemblies in the terminal 500. The power supply 509 may be alternating current, direct current, a disposable battery, or a rechargeable battery. In the case that the power supply 509 includes the rechargeable battery, the rechargeable battery may be charged in a wired mode or a wireless mode. The rechargeable battery may also support the fast-charging technology.

In some embodiments, the terminal 500 further includes one or more sensors 510. The one or more sensors 510 include, but are not limited to, an acceleration sensor 511, a gyroscope sensor 512, a pressure sensor 513, a fingerprint sensor 514, an optical sensor 515, and a proximity sensor 516.

The acceleration sensor 511 is configured to detect magnitude of accelerations on three coordinate axes of a coordinate system established by the terminal 500. For example, the acceleration sensor 511 is configured to detect components of gravitational acceleration on the three coordinate axes. The processor 501 controls the display screen 505 to display a user interface in a lateral view or a vertical view based on gravitational acceleration signals acquired by the acceleration sensor 511. The acceleration sensor 511 may be further configured to acquire motion data of a game or a user.

The gyroscope sensor 512 is configured to detect a body direction and a rotational angle of the terminal 500. The gyroscope sensor 512 may cooperate with the acceleration sensor 511 to acquire the user's 3D actions on the terminal 500. Based on the data acquired by the gyroscope sensor 512, the processor 501 can implement the following functions: motion sensing (such as changing the UI based on a user's tilt operation), image stabilization during shooting, game control and inertial navigation.

The pressure sensor 513 may be disposed on a side frame of the terminal 500 and/or a layer under the display screen 505. In the case that the pressure sensor 513 is disposed on the side frame of the terminal 500, a user's holding signal to the terminal 500 can be detected. The processor 501 performs left/right hand recognition or a quick operation based on the holding signal acquired by the pressure sensor 513. In the case that the pressure sensor 513 is disposed on the layer under the display screen 505, the processor 501 controls an operable control on the UI based on a user's pressure operation on the display screen 505. The operable control includes at least one of a button control, a scroll bar control, an icon control, and a menu control.

The fingerprint sensor 514 is configured to acquire a user's fingerprint. The user's identity is recognized by the processor 501 or by the fingerprint sensor 514 based on the acquired fingerprint by the fingerprint sensor 514. In the case that the user's identity is identified as a trusted identity, the user is authorized by the processor 501 to perform a related sensitive operation, such as unlocking the screen, viewing encrypted information, downloading software, payment, changing settings, and the like. The fingerprint sensor 514 may be disposed on the front, rear, or side surface of the terminal 500. In the case that the terminal 500 is provided with a physical button or its manufacturer's logo, the fingerprint sensor 514 may be integrated with the physical button or the its manufacturer's logo.

The optical sensor 515 is configured to acquire intensity of ambient light. In one embodiment, the processor 501 may control display brightness of the display screen 505 based on the intensity of ambient light acquired by the optical sensor 515. In some embodiments, in the case that the intensity of ambient light is high, the display brightness of the display screen 505 is increased; and in the case that the intensity of ambient light is low, the display brightness of the display screen 505 is decreased. In another embodiment, the processor 501 is further configured to dynamically adjust imaging parameters of the camera assembly 506 based on the intensity of ambient light acquired by the optical sensor 515.

The proximity sensor 516, also referred to as a distance sensor, is generally disposed on the front panel of the terminal 500. The proximity sensor 516 is configured to acquire a distance between a user and the front surface of the terminal 500. In one embodiment, in the case that a distance between the user and the front surface of the terminal 500 detected by the proximity sensor 516 gradually becomes decreases, the display screen 505 is controlled by the processor 501 to switch from a screen-on state to a screen-off state. In the case that the distance between the user and the front surface of the terminal 500 detected by the proximity sensor 516 gradually increases, the display screen 505 is controlled by the processor 501 to switch from the screen-off state to the screen-on state.

It can be understood by those skilled in the art that the structure shown in FIG. 5 does not constitute a limitation to the terminal 500. More or less components than those illustrated may be included, or some components may be combined, or different component arrangements may be provided.

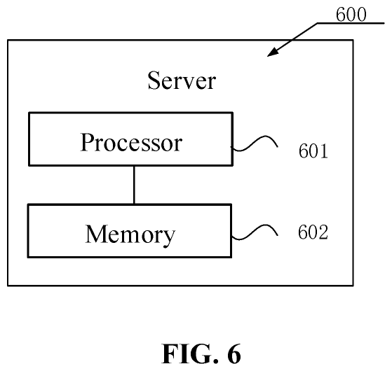

FIG. 6 is a schematic structural diagram of a server according to an exemplary embodiment. Significant differences may be generated when the server 600 has different configurations or performances. The server 600 may include one or more processors (CPU) 601 and one or more memories 602 storing one or more instructions therein, wherein the one or more instructions, when loaded and executed by the one or more processors 601, cause the one or more processors 601 to perform the method for generating the clipping template according to each of the above method embodiments. The server may further include components such as a wired or wireless network interface, a keyboard, and an input/output interface, and other components for input and output. The server may further include other components for implementing device functions, which are not repeated herein.

The servers shown in FIGS. 5 and 6 are both electronic devices. The electronic device includes one or more processors, and one or more memories configured to store one or more instructions executable by the one or more processors, wherein the one or more processors, when loading and executing the one or more instructions, are caused to perform the method for generating the clipping template as described above.

In an exemplary embodiment, a non-transitory storage medium including one or more instructions is further provided, such as a memory including one or more instructions. The one or more instructions, when loaded and executed by a processor of an electronic device, cause the electronic device to perform the method for generating the clipping template according to the above method embodiment.

In an exemplary embodiment, a computer program product including one or more instructions is further provided, wherein the one or more instructions, when loaded and executed by a processor of an electronic device, cause the electronic device to perform the method for generating the clipping template according to the above method embodiment.

A person skilled in the art can easily envisage other solutions of the present disclosure in consideration of the specification and practice of the disclosure herein. The present disclosure is intended to cover any variations, purposes or applicable changes of the present disclosure. Such variations, purposes or applicable changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the appended claims.

It should be noted that, the present disclosure is not limited to the precise structures that have been described above and shown in the accompanying drawings, and can be modified and changed in many ways without departing from the scope of the present disclosure. The scope of the present disclosure is defined by the appended claims.

What is claimed is:

1. A method for generating a clipping template, the clipping template being configured to clip a multimedia resource, the method comprises:
acquiring clipping information of a target multimedia resource in response to a template generation request for the target multimedia resource, wherein the clipping information of the target multimedia resource comprises at least one of clip operation information or clipping material information;
selecting clipping information conforming to a target type from the clipping information of the target multimedia resource, and determining template data based on the selected clipping information; and
generating the clipping template based on the template data.

2. The method according to claim 1, wherein the clipping information of the target multimedia resource comprises the clip operation information, the clip operation information comprises an operation type and/or operation content of at least one clip operation, and the target type comprises a target operation type; and
said selecting the clipping information conforming to the target type from the clipping information of the target multimedia resource, and determining the template data based on the selected clipping information comprises:
selecting clip operation information conforming to the target operation type from the clip operation information of the target multimedia resource, and determining the template data based on the selected clip operation information.

3. The method according to claim 2, wherein the clip operation information further comprises an operation sequence of a plurality of clip operations; and
said determining the template data based on the selected clip operation information comprises:
correlating the selected clip operation information based on the operation sequence, and determining the correlated clip operation information as the template data.

4. The method according to claim 1, wherein the clipping information of the target multimedia resource comprises the clipping material information, wherein the clipping material information comprises a material type, material content, or a material acquisition manner of at least one material, and the target type comprises a target material type; and
said selecting the clipping information conforming to the target type from the clipping information of the target multimedia resource, and determining the template data based on the selected clipping information comprises:
selecting clipping material information conforming to the target material type from the clipping material information of the target multimedia resource, and determining the selected clipping material information as the template data.

5. The method according to claim 1, wherein the target type comprises a target operation type, and the template data comprises clip operation information conforming to the target operation type; and
said generating the clipping template based on the template data comprises:
generating a clip operation option based on the clip operation information conforming to the target operation type; and
generating the clipping template, wherein the clipping template comprises the clip operation option.

6. The method according to claim 5, wherein the clip operation information conforming to the target operation type is correlated based on an operation sequence of a plurality of clip operations; and said generating the clipping template based on the template data comprises:
generating clip operation options and a trigger sequence of the clip operation options based on a correlation relationship of the clip operation information conforming to the target operation type; and
generating the clipping template, wherein the clipping template comprises at least two clip operation options and a trigger sequence of the at least two clip operation options.

7. The method according to claim 1, wherein the target type comprises a target material type, and the template data comprises clipping material information conforming to the target material type; and
said generating the clipping template based on the template data comprises:
generating a material option based on the clipping material information conforming to the target material type; and
generating the clipping template, wherein the clipping template comprises the material option.

8. The method according to claim 7, further comprising:
generating a material acquisition path associated with the material option based on a material type and a material acquisition manner in the clipping material information conforming to the target material type; and
adding, based on material content in the clipping material information conforming to the target material type, the material content to a directory indicated by the material acquisition path.

9. The method according to claim 1, wherein said acquiring the clipping information of the target multimedia resource in response to the template generation request for the target multimedia resource comprises:
acquiring a clip operation log of the target multimedia resource in response to the template generation request; and
extracting the clip operation information of the target multimedia resource from the clip operation log, wherein the clip operation information is configured to describe clip operations operated for generating the target multimedia resource or configured to describe a final clip operation result for generating the target multimedia resource.

10. The method according to claim 1, wherein said acquiring the clipping information of the target multimedia resource in response to the template generation request for the target multimedia resource comprises:
acquiring a clip operation log of the target multimedia resource in response to the template generation request; and
extracting the clipping material information of the target multimedia resource from the clip operation log, wherein the clipping material information at least comprises a material type, material content, or a material acquisition manner of at least one material.

11. The method according to claim 1, wherein said acquiring the clipping information of the target multimedia resource in response to the template generation request for the target multimedia resource comprises:
acquiring an original multimedia resource in response to the template generation request, wherein the target multimedia resource is acquired by clipping the original multimedia resource; and
acquiring the clipping information of the target multimedia resource by comparing the original multimedia resource and the target multimedia resource.

12. The method according to claim 1, further comprising:
displaying the clipping template;
in response to a preview instruction for the clipping template, determining a template option corresponding to an operation position of the preview instruction, wherein the template option comprises at least one of a clip operation option or a clipping material option; and
displaying preview content corresponding to the template option based on template data corresponding to the template option.

13. The method according to claim 12, wherein a plurality of operation positions are corresponding to the preview instruction, and each operation position is corresponding to one template option; and
said displaying the preview content corresponding to the template option based on the template data corresponding to the template option comprises:
displaying composite content based on template data corresponding to the template options, wherein the composite content is acquired by compositing the preview content corresponding to the template options.

14. The method according to claim 13, wherein said displaying the composite content based on the template data corresponding to the template options comprises:
acquiring a plurality of preview content corresponding to the template options based on the template data corresponding to the template options;
acquiring the composite content by compositing the plurality of preview content; and
displaying the composite content.

15. An electronic device, comprising:
one or more processors; and
one or more memories configured to store one or more instructions executable by the one or more processors;
wherein the one or more processors, when loading and executing the one or more instructions, are caused to:
acquire clipping information of a target multimedia resource in response to a template generation request for the target multimedia resource, wherein the clipping information of the target multimedia resource comprises at least one of clip operation information or clipping material information;
select clipping information conforming to a target type from the clipping information of the target multimedia resource, and determine template data based on the selected clipping information; and
generate a clipping template based on the template data, wherein the clipping template is configured to clip a multimedia resource.

16. The electronic device according to claim 15, wherein the clipping information of the target multimedia resource comprises the clip operation information, the clip operation information comprises an operation type and/or operation content of at least one clip operation, and the target type comprises a target operation type; and
the one or more processors, when loading and executing the one or more instructions, are further caused to:
select clip operation information conforming to the target operation type from the clip operation information of the target multimedia resource, and determine the template data based on the selected clip operation information.

17. The electronic device according to claim 16, wherein the clip operation information further comprises an operation sequence of a plurality of clip operations; and
the one or more processors, when loading and executing the one or more instructions, are further caused to:
correlate the selected clip operation information based on the operation sequence, and determine the correlated second clip operation information as the template data.

18. The electronic device according to claim 15, wherein the target type comprises a target operation type, and the template data comprises clip operation information conforming to the target operation type; and
the one or more processors, when loading and executing the one or more instructions, are further caused to:
generate a clip operation option based on the clip operation information conforming to the target operation type; and
generate the clipping template, wherein the clipping template comprises the clip operation option.

19. The electronic device according to claim 18, wherein the clip operation information conforming to the target operation type is correlated based on an operation sequence of a plurality of clip operations; and
the one or more processors, when loading and executing the one or more instructions, are further caused to:
generate clip operation options and a trigger sequence of the clip operation options based on a correlation relationship of the clip operation information conforming to the target operation type; and
generate the clipping template, wherein the clipping template comprises at least two clip operation options and a trigger sequence of the at least two clip operation options.

20. A storage medium storing one or more instructions therein, wherein the one or more instructions, when loaded and executed by a processor of an electronic device, cause the electronic device to:
acquire clipping information of a target multimedia resource in response to a template generation request for the target multimedia resource, wherein the clipping information of the target multimedia resource comprises at least one of clip operation information or clipping material information;
select clipping information conforming to a target type from the clipping information of the target multimedia resource, and determine template data based on the selected clipping information; and
generate a clipping template based on the template data, wherein the clipping template is configured to clip a multimedia resource.
